(19) United States
(12) Patent Application Publication
(10) Pub. No.: US 2016/0264826 A1
(43) Pub. Date: Sep. 15, 2016

(54) PRESSURE-SENSITIVE ADHESIVE LAYER-CARRYING OPTICAL MEMBER, IMAGE DISPLAY DEVICE, AND METHOD FOR PRODUCING PRESSURE-SENSITIVE ADHESIVE LAYER-CARRYING OPTICAL MEMBER

(71) Applicant: NITTO DENKO CORPORATION, Ibaraki-shi, Osaka (JP)

(72) Inventors: Kayo Shimokawa, Ibaraki-shi (JP); Toshitaka Takahashi, Ibaraki-shi (JP); Yousuke Makihata, Ibaraki-shi (JP); Kenichi Okada, Ibaraki-shi (JP); Toshitsugu Hosokawa, Ibaraki-shi (JP); Masakuni Fujita, Ibaraki-shi (JP)

(73) Assignee: NITTO DENKO CORPORATION, Ibaraki-shi, Osaka (JP)

(21) Appl. No.: 15/032,838

(22) PCT Filed: Aug. 1, 2014
(86) PCT No.: PCT/JP2014/070358

§ 371 Date: Apr. 28, 2016

(30) Foreign Application Priority Data
Oct. 30, 2013 (JP) 2013-225757

(51) Int. Cl. C09J 7/02; G02B 5/30

(52) U.S. Cl. CPC C09J 7/0246; C09J 7/026; G02B 5/3033; C09J 2201/606; C09J 2481/00; C09J 2201/122; C09J 2433/00

(57) ABSTRACT

Provided are a pressure-sensitive adhesive layer-carrying optical member having good antistatic properties, having high tackiness between an optical member and a pressure-sensitive adhesive layer made from a water-dispersible pressure-sensitive adhesive composition, and allowing the pressure-sensitive adhesive layer to have high durability; an image display device including such a pressure-sensitive adhesive layer-carrying optical member; and a method for producing such a pressure-sensitive adhesive layer-carrying optical member, in which the pressure-sensitive adhesive layer-carrying optical member includes a pressure-sensitive adhesive layer made from a water-dispersible pressure-sensitive adhesive composition, an anchor layer made from an anchor-layer-forming coating liquid, and an optical member, wherein the anchor-layer-forming coating liquid includes a polythiophene based polymer, an oxazoline group-containing polymer, and an aqueous solvent including 60% by weight or more of water, and the anchor layer is interposed between the pressure-sensitive adhesive layer and the optical member.

### TECHNICAL FIELD

The invention relates to a pressure-sensitive adhesive layer-Carrying optical member, and image display device. The invention also relates to a method for producing a pressure-sensitive adhesive layer-carrying optical member.

### BACKGROUND ART

Liquid crystal display devices, organic EL display devices, etc. have an image-forming mechanism including polarizing elements as essential components. For example, therefore, in a liquid crystal display device, polarizing elements are essentially arranged on both sides of a liquid crystal cell, and generally, polarizing films are attached as the polarizing elements. Besides polarizing films, various optical elements for improving display quality have become used in display panels such as liquid crystal panels and organic EL panels. Front face plates are also used to protect image display devices such as liquid crystal display devices, organic EL display devices, CRTs, and PDPs or to provide a high-grade appearance or a differentiated design. Examples of parts used in image display devices such as liquid crystal display devices and organic EL display devices or parts used together with image display devices, such as front face plates, include retardation plates for preventing discoloration, viewing angle-widening films for improving the viewing angle of liquid crystal displays, brightness enhancement films for increasing the contrast of displays, and surface treatment films such as hard-coat films for use in imparting scratch resistance to surfaces, anti-glare treatment films for preventing glare on image display devices, and anti-reflection films such as anti-reflective films and low-reflective films. These films are generically called optical films.

When such an optical film is bonded onto a display panel such as a liquid crystal cell and organic EL panel, or onto a front plate thereof, a pressure-sensitive adhesive is usually used. About bonding between an optical film, and a display panel such as a liquid crystal cell or organic EL panel, a front plate, or an optical film, usually, a pressure-sensitive adhesive is used to cause the individual members to be bonded to adhere closely onto each other to decrease light loss. In such cases, a pressure-sensitive adhesive layer-carrying optical film, in which a pressure-sensitive adhesive layer is beforehand provided on a single side surface of an optical film, is generally used since the pressure-sensitive adhesive layer-carrying optical film has an advantage that no drying step is required for bonding and fixing the optical film, and the like.

A surface protective film is attached to the surface of the pressure-sensitive adhesive layer-carrying optical film in order to prevent the surface from being scratched or stained with dirt in the manufacturing process and the transportation after the manufacture. Unfortunately, when the surface protective film is peeled off from the pressure-sensitive adhesive layer-carrying optical film, static electricity can be generated between the pressure-sensitive adhesive layer-carrying optical film and the surface protective film (what is called peeling-induced static build-up). If a voltage is applied to a liquid crystal with the generated static electricity remaining thereon, a problem can occur in which the liquid crystal molecules lose their orientation and the panel suffers from defects.

Known examples of a pressure-sensitive adhesive film capable of preventing such peeling-induced static build-up include a pressure-sensitive adhesive film including a substrate, a pressure-sensitive adhesive layer or layers provided on one or both sides of the substrate, and an undercoat layer interposed between the substrate and the pressure-sensitive adhesive layer and containing an oxazoline group-containing resin and an organometallic compound; and a pressure-sensitive adhesive film including a substrate, a pressure-sensitive adhesive layer, and an antistatic layer provided between the substrate and the pressure-sensitive adhesive layer and containing a polythiophene conductive polymer (see, for example, Patent Documents 1 and 2).

### PRIOR ART DOCUMENTS

### Patent Documents

Patent Document 1: JP-A-2007-70611

Patent Document 2: JP-A-2007-262318

### SUMMARY OF THE INVENTION

### Problems to be Solved by the Invention

In recent years, the tightening of environmental protection regulations has required a reduction in the consumption of organic solvents also in the field of optical displays, and solvent-type pressure-sensitive adhesives using organic solvents have been required to be replaced with water-dispersible pressure-sensitive adhesives using water as a dispersion medium.

The pressure-sensitive adhesive films described in Patent Documents 1 and 2, which contain a specific undercoat or antistatic layer, can prevent peeling-induced static build-up. In these films, however, the undercoat or antistatic layer has low compatibility with a pressure-sensitive adhesive layer made from a water-dispersible pressure-sensitive adhesive composition, and the tackiness between the pressure-sensitive adhesive layer and the substrate is not sufficient.

In general, an antistatic layer has the function of ensuring conductivity between layers. For this function, therefore, the respective layers (the substrate and the pressure-sensitive adhesive layer) need to be uniformly bonded together. In conventional techniques, therefore, the antistatic layer-forming composition contains a lipophilic component such as an alcohol in order to ensure sufficient wetting ability to the resin substrate. The lipophilic component can reduce the compatibility between the antistatic layer and the pressure-sensitive adhesive layer made from a water-dispersible pressure-sensitive adhesive composition and tend to cause delamination, which will lead to a reduction in the anchoring strength of the pressure-sensitive adhesive layer to the substrate such as an optical member.

It is therefore an object of the invention to provide a pressure-sensitive adhesive layer-carrying optical member having good antistatic properties, having high tackiness between an optical member and a pressure-sensitive adhesive layer made from a water-dispersible pressure-sensitive adhesive composition, and allowing the pressure-sensitive adhesive layer to have high durability. It is another object of the invention to provide an image display device including such a pressure-sensitive adhesive layer-carrying optical member and to provide a method for producing such a pressure-sensitive adhesive layer-carrying optical member.

### Means for Solving the Problems

As a result of intensive studies to solve the problems, the inventors have found that when a pressure-sensitive adhesive layer-carrying optical member is produced so as to have the features described below, the resulting pressure-sensitive adhesive layer-carrying optical member can have good antistatic properties, have high tackiness between an optical member and a pressure-sensitive adhesive layer made from a water-dispersible pressure-sensitive adhesive composition, and allow the pressure-sensitive adhesive layer to have high durability.

Thus, the present invention relates to a

### Effect of the Invention

According to the invention, the anchor layer made from the anchor-layer-forming coating liquid including a polythiophene based polymer, which has high conductivity and high transparency, an oxazoline group-containing polymer, and an aqueous solvent including 60% by weight or more of water is placed between the optical member and the pressure-sensitive adhesive layer made from a water-dispersible pressure-sensitive adhesive composition. This structure can provide a pressure-sensitive adhesive layer-carrying optical member having good antistatic properties, having high tackiness between the pressure-sensitive adhesive layer and the optical member, and allowing the pressure-sensitive adhesive layer to have high durability.

### MODE FOR CARRYING OUT THE INVENTION

1. Pressure-Sensitive Adhesive Layer-Carrying Optical Member

The pressure-sensitive adhesive layer-carrying optical member of the invention includes a pressure-sensitive adhesive layer made from a water-dispersible pressure-sensitive adhesive composition, an anchor layer made from an anchor-layer-forming coating liquid, and an optical member, wherein

the anchor-layer-forming coating liquid includes a polythiophene based polymer, an oxazoline group-containing polymer, and an aqueous solvent including 60% by weight or more of water, and

the anchor layer is interposed between the pressure-sensitive adhesive layer and the optical member.

(1) Anchor Layer

The anchor layer used in the invention is made from an anchor-layer-forming coating liquid including a polythiophene based polymer, an oxazoline group-containing polymer, and an aqueous solvent including 60% by weight or more of water.

Various forms of the polythiophene based polymer may be used. A water-soluble or water dispersible polymer can be suitably used.

The word “water-soluble” or “water-solubility” denotes that the solubility of any compound in 100 g of water is 5 g or more. The solubility of the water-soluble polythiophene based polymer in 100 g of water is preferably from 20 to 30 g. The polythiophene based polymer that is water-dispersible is a polymer that is dispersible in water in the state that the polymer is in the form of fine particles. A water-dispersible liquid is small in liquid viscosity to be easily used for thin film coating, and further the resultant painted layer is excellent in evenness. The size of the fine particles is preferably 1 μm or less from the viewpoint of the evenness of the anchor layer.

The water-soluble or water-dispersible polythiophene based polymer preferably has, in the molecule thereof, a hydrophilic functional group. Examples of the hydrophilic functional group include a sulfonic group, an amino group, an amide group, an imino group, a quaternary ammonium salt, a hydroxyl group, a mercapto group, a hydrazino group, a carboxyl group, a sulfate group, and a phosphate group; and salts of these groups. When the polymer has in the molecule a hydrophilic functional group, the polymer is easily soluble in water, or is easily dispersible, in the form of fine particles, in water. Thus, the water-soluble or water-dispersible polythiophene based polymer can easily be prepared.

The weight-average molecular weight of the polythiophene based polymer is preferably 400000 or less, more preferably 300000 or less in terms of that of polystyrene. If the weight-average molecular weight is more than the upper value, the polymer tends not to satisfy the water-solubility or water-dispersibility. When such a polymer is used to prepare a coating liquid, a solid of the polymer tends to remain in the coating liquid, or the polymer tends to be increased in viscosity so that an anchor layer with even film thickness is hard to be formed.

Examples of the water-soluble or water-dispersible polythiophene based polymer include DENATRON series polymers manufactured by Nagase ChemteX Corp (for example, DENATRON P-580W).

The content of the polythiophene based polymer in the anchor-layer-forming coating liquid is preferably from 0.005 to 5% by weight, more preferably from 0.01 to 3% by weight, even more preferably from 0.01 to 1% by weight, further more preferably 0.01 to 0.5% by weight. When the polythiophene based polymer content is in these ranges, the anchor layer can have a higher level of conductivity and optical properties, which is preferred. If the polythiophene based polymer content is less than 0.005% by weight, the anchor layer made from the coating liquid may have an insufficient antistatic function, and if the polythiophene based polymer content is more than 5% by weight, the anchor layer may have a lower level of optical properties (a lower level of transmittance), which is not preferred.

The content of the polythiophene based polymer in the anchor layer is preferably from 5 to 90% by weight, more preferably from 5 to 80% by weight, even more preferably from 5 to 50% by weight, further more preferably from 5 to 30% by weight. When the polythiophene based polymer content is in these ranges, the anchor layer can have a higher level of conductivity, which is preferred.

The oxazoline group-containing polymer contains a main chain being of an acryl skeleton or a styrene skeleton and has an oxazoline group in aside chain of the main chain, preferably an oxazoline group-containing acrylic polymer having a main chain being of an acryl skeleton and having an oxazoline group in a side chain of the main chain.

Examples of the oxazoline group include 2-oxazoline group, 3-oxazoline group and 4-oxazoline group. Among these, 2-oxazoline group is preferable. The 2-oxazoline group is generally represented by the following general formula (1):

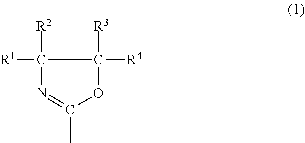

in the general formula (1), R¹ to R⁴ each independently represents a hydrogen atom, a halogen atom, an alkyl group, an aralkyl group, a phenyl group or a substituted phenyl group.

The oxazoline group-containing polymer may contain polyoxyalkylene-group in addition to the oxazoline group.

The number average molecular weight of the oxazoline group-containing polymer is preferably 5,000 or more, more preferably 10,000 or more, and usually 1,000,000 or less. When the number average molecular weight is lower than 5,000, cohesive failure may be caused because of poor strength of the anchor-layer, whereby an anchoring force may not be improved. When the number average molecular weight is higher than 1,000,000, workability may be inferior. The oxazoline value of the oxazoline group-containing polymer is preferable, for example, 1,500 g solid/eq. or less, more preferably 1,200 g solid/eq. or less. When the oxazoline value is larger than 1,500 g solid/eq., the amount of the oxazoline group in a molecule decreases, whereby the anchoring force may not be improved.

Since the oxazoline group of the oxazoline group-containing polymer reacts with a functional group, such as carboxyl group and hydroxyl group, contained in the water-dispersible pressure-sensitive adhesive composition at relatively low temperatures, the oxazoline group-containing polymer reacts with the functional group or the like in the pressure-sensitive adhesive layer and can firmly adhere to the pressure-sensitive adhesive layer when contained in the anchor-layer.

Examples of the oxazoline group-containing polymer include oxazoline group-containing acrylic polymers such as EPOCROS WS-300, EPOCROS WS-500, EPOCROS WS-700, manufactured by Nippon Shokubai Co., Ltd.; and oxazoline group-containing acryl/styrene polymers such as EPOCROS K-1000 series, EPOCROS K-2000 series, manufactured by Nippon Shokubai Co., Ltd. The oxazoline group-containing polymers may be used alone or in the form of a mixture of two or more thereof.

The content of the oxazoline group-containing polymer in the anchor-layer-forming coating liquid is preferably from 0.005 to 5% by weight, more preferably from 0.01 to 3% by weight, even more preferably from 0.01 to 1% by weight, most preferably from 0.01 to 0.5% by weight. When the content of the oxazoline group-containing polymer is in these ranges, the anchor layer can have a higher level of adhesion to the pressure-sensitive adhesive layer made from the water-dispersible pressure-sensitive adhesive composition and can also surely have a certain level of strength, which is preferred.

The content of the oxazoline group-containing polymer in the anchor layer is preferably from 10 to 80% by weight, more preferably from 20 to 70% by weight. When the content of the oxazoline group-containing polymer is in these ranges, the anchor layer can have improved adhesion to the pressure-sensitive adhesive layer made from the water-dispersible pressure-sensitive adhesive composition, which is preferred.

The aqueous solvent to be used includes 60% by weight or more of water. The water content is preferably 70% by weight or more, more preferably 90% by weight or more, even more preferably 95% by weight or more, further more preferably 97% by weight or more, still more preferably 99% by weight or more, yet more preferably 100% by weight (water alone). For example, a mixed solvent including 60 to 100% by weight of water and 0 to 40% by weight of an alcohol may be used. In this case, the alcohol content of the solvent composition is preferably 40% by weight or less, more preferably 30% by weight or less, even more preferably 10% by weight or less, furthermore preferably 5% by weight or less, still more preferably 3% by weight or less, yet more preferably 1% by weight or less. In particular, no use of any alcohol is preferred. Most of the aqueous solvent is removed in the step of drying the anchor layer being formed. However, if the alcohol content of the aqueous solvent is over the range, a plasticizer and other components may leach out of the surface of the optical member in contact with the anchor layer, leading to a reduction in the compatibility between the optical member and the pressure-sensitive adhesive layer made from the water-dispersible pressure-sensitive adhesive composition. In the invention, the use of an aqueous solvent including 60% by weight or more of water makes it possible to prevent a plasticizer and other components from leaching out of the surface of the optical member, which can improve the compatibility between the optical member and the pressure-sensitive adhesive layer made from the water-dispersible pressure-sensitive adhesive composition, so that higher tackiness can be provided between the pressure-sensitive adhesive layer and the optical member.

The alcohol content is preferably 30% by weight or less, more preferably 20% by weight or less, even more preferably 10% by weight or less, based on the total weight of the anchor-layer-forming coating liquid.

Preferably, the alcohol is hydrophilic at room temperature (25° C.) and miscible particularly with water in any proportion. The alcohol with such features is preferably an alcohol of 1 to 6 carbon atoms, more preferably an alcohol of 1 to 4 carbon atoms, even more preferably an alcohol of 1 to 3 carbon atoms. Examples of the alcohol with such features include methanol, ethanol, n-propanol, isopropyl alcohol, n-butanol, isobutanol, sec-butanol, tert-butanol, n-amyl alcohol, isoamyl alcohol, sec-amyl alcohol, tert-amyl alcohol, 1-ethyl-1-propanol, 2-methyl-1-butanol, n-hexanol, and cyclohexanol. These may be used alone or in a mixture of two or more.

In the present invention, the anchor-layer-forming coating liquid may contain a polyoxyalkylene group-containing polymer together with the polythiophene based polymer, oxazoline group-containing polymer, and the aqueous solvent. The polyoxyalkylene group-containing polymer is, for example, a polyoxyalkylene-group-containing poly(meth)acrylate having a poly(meth)acrylate polymer as a main chain and having a polyoxyalkylene group, such as a polyoxyethylene group or a polyoxypropylene group, in a side chain. The amount of the addition of the polyoxyalkylene group-containing polymer is not limited and may be determined as appropriate in the range where the effects of the invention are not impaired.

In addition to the components described above, the anchor-layer-forming coating liquid for use in the invention may also contain a binder component for improving the anchoring properties or the tackiness between the optical member and the pressure-sensitive adhesive layer.

For improving the anchoring strength of the pressure-sensitive adhesive, any resin (polymer) having an organic reactive group such as a polyurethane resin based binder such as a water-soluble or water-dispersible polyurethane resin based binder, an epoxy resin based binder, an isocyanate resin based binder, a polyester resin based binder, a polymer having in the molecule thereof an amino group, and a binder of an acrylic resin that may be of various types and contains, for example, an oxazoline group may be used as the binder component. The oxazoline group-containing polymer for use in the invention also functions as a binder.

The content of the binder resin in the anchor-layer-forming coating liquid is preferably from 0.005 to 5% by weight, more preferably from 0.01 to 3% by weight, even more preferably from 0.01 to 1% by weight, most preferably from 0.01 to 0.5% by weight.

An additive may be blended into the anchor-layer-forming coating liquid if necessary. Examples of the additive include a leveling agent, an antifoaming agent, a thickener, and an antioxidant. Of these additives, preferred is a leveling agent (for example, one having an acetylene skeleton). The ratio of the additive (s) is preferably from about 0.01 to 500 parts by weight, more preferably from 0.1 to 300 parts by weight, even more preferably from 1 to 100 parts by weight for 100 parts by weight of the binder resin(solid content).

The solid concentration of anchor-layer-forming coating liquid is preferably 0.01 to 10% by weight, more preferably 0.01 to 3% by weight, even more preferably 0.1 to 3% by weight.

The pressure-sensitive adhesive layer-carrying optical member of the invention includes an optical member, an anchor layer made from the anchor-layer-forming coating liquid, and a pressure-sensitive adhesive layer provided on at least one side of the optical member with the anchor layer interposed therebetween. The anchor layer is interposed between the pressure-sensitive adhesive layer and the optical member. In the pressure-sensitive adhesive layer-carrying optical member, the pressure-sensitive adhesive layer may be provided on one side of the optical member or on each of both sides of the optical member. The method for forming the anchor layer will be described later.

The anchor layer used in the invention preferably provides a reduction in single-piece transmittance of 1.0% or less, more preferably 0.3% or less, even more preferably 0.2% or less. In the invention, the anchor layer-induced reduction in single-piece transmittance means a reduction in transmittance, which is determined by a process including measuring the transmittance of the optical member such as a polarizing film before the anchor layer is formed thereon, then measuring the transmittance of the anchor layer-carrying optical member (such as an anchor layer-carrying polarizing film), and subtracting the transmittance of the optical member (polarizing film) after the formation from the transmittance of the optical member (polarizing film) before the formation.

(2) Pressure-Sensitive Adhesive Layer

The pressure-sensitive adhesive layer is made from a water-dispersible pressure-sensitive adhesive composition. The water-dispersible pressure-sensitive adhesive composition is an aqueous dispersion containing at least a base polymer dispersed in water. Usually, the aqueous dispersion to be used contains a base polymer dispersed in the presence of a surfactant. However, an aqueous dispersion containing a self-dispersible base polymer dispersed by itself in water may also be used.

The water-dispersible pressure-sensitive adhesive composition may be any of various pressure-sensitive adhesives, examples of which include rubber-based pressure-sensitive adhesives, acrylic pressure-sensitive adhesives, silicone-based pressure-sensitive adhesives, polyurethane-based pressure-sensitive adhesives, vinyl alkyl ether-based pressure-sensitive adhesives, polyvinyl alcohol-based pressure-sensitive adhesives, polyvinylpyrrolidone-based pressure-sensitive adhesives, polyacrylamide-based pressure-sensitive adhesives, cellulose-based pressure-sensitive adhesives, polyester-based pressure-sensitive adhesives, and fluoride pressure-sensitive adhesives. In particular, the invention preferably uses a water-dispersible acrylic pressure-sensitive adhesive, which has a high level of optical transparency, weather resistance, and heat resistance and exhibits a suitable level of adhesive properties such as wetting ability, cohesiveness, and adhesion.

In the invention, the water-dispersible pressure-sensitive adhesive composition is preferably an aqueous dispersion containing (A) a (meth)acryl-based copolymer with a glass transition temperature of −55° C. or more and less than 0° C. and/or (B) another (meth)acryl-based copolymer with a glass transition temperature of 0° C. or more. In the invention, the water-dispersible pressure-sensitive adhesive composition may include emulsion particles each having a core-shell structure in which the (meth)acryl-based copolymer (B) forms a core layer and the (meth)acryl-based copolymer (A) forms a shell layer.

The glass transition temperature of the (meth)acryl-based copolymer (A) is preferably −20° C. or less, more preferably −30° C. or less. The glass transition temperature is preferably −50° C. or more, more preferably −45° C. or more. When the glass transition temperature falls within the range, a reduction in cohesive strength can be prevented while the tackiness of the pressure-sensitive adhesive is assured.

The glass transition temperature of the (meth)acryl-based copolymer (B) is preferably 50° C. or more, more preferably 60° C. or more, even more preferably 70° C. or more. The glass transition temperature is preferably 180° C. or less, more preferably 110° C. or less, even more preferably 100° C. or less, further more preferably 90° C. or less. When the glass transition temperature of the (meth)acryl-based copolymer (B) falls within the range, the reworkability or the like can be improved.

The difference (B−A) between the glass transition temperatures of the (meth)acryl-based copolymer (A) and the (meth)acryl-based copolymer (B) is preferably 50° C. or more, more preferably 70° C. or more, even more preferably 80° C. or more. When the glass transition temperature difference falls within the range, the pressure-sensitive adhesive can have reliable adhesion, be prevented from having lower cohesive strength, and be good in reworkability and so on.

The glass transition temperatures of the (meth)acryl-based copolymers (A) and (B) are theoretical values each calculated from the following FOX equation taking into account the types and contents of the monomer units of each polymer.

FOX Equation:

$$\frac{1}{Tg} = \frac{{W}_{1}}{{Tg}_{1}} + \frac{{W}_{2}}{{Tg}_{2}} + … + \frac{{W}_{n}}{{Tg}_{n}}$$

in the FOX equation, Tg: the glass transition temperature (K) of the polymer; Tg₁, Tg₂, . . . Tgₙ: the glass transition temperatures (K) of the homopolymers of the respective monomers; W₁, W₂, . . . Wₙ: the weight fractions of the respective monomers)

It should be noted that the glass transition temperatures of the (meth)acryl-based copolymers (A) and (B) are calculated based on the monofunctional monomers. Namely, even when the polymers each contain a polyfunctional monomer as a monomer unit, the polyfunctional monomer is neglected in the calculation of the glass transition temperature, because the polyfunctional monomer is used in a small amount so that its influence on the glass transition temperature of the copolymer is low. It should also be noted that an alkoxysilyl group-containing monomer is recognized as a polyfunctional monomer and therefore neglected in the calculation of the glass transition temperatures. The theoretical glass transition temperatures calculated from the FOX equation well agree with actual glass transition temperatures determined from differential scanning calorimetry (DSC), dynamic viscoelasticity, etc.

The (meth)acryl-based copolymer (A) may have any monomer unit and any composition that satisfy the glass transition temperature requirements. For example, the (meth)acryl-based copolymer (A) is preferably one obtained by emulsion polymerization of a monomer component including an alkyl (meth)acrylate and a carboxyl group-containing monomer. The term “alkyl (meth)acrylate” refers to alkyl acrylate and/or alkyl methacrylate, and “(meth)” is used in the same meaning in the description.

In view of emulsion polymerization reactivity, the alkyl (meth)acrylate used to form the (meth)acryl-based copolymer (A) preferably has a water solubility in a specific range, and an alkyl acrylate having an alkyl group of 1 to 18 carbon atoms is preferably used to form a major component, so that the glass transition temperature can be easily controlled. Examples of the alkyl acrylate include methyl acrylate, ethyl acrylate, propyl acrylate, n-butyl acrylate, tert-butyl acrylate, n-hexyl acrylate, cyclohexyl acrylate, 2-ethylhexyl acrylate, n-octyl acrylate, lauryl acrylate, tridecyl acrylate, stearyl acrylate, and other alkyl esters of acrylic acid. These may be used alone or in combination of two or more. Among these, an alkyl acrylate having an alkyl group of 3 to 9 carbon atoms is preferable, such as propyl acrylate, n-butyl acrylate, 2-ethylhexyl acrylate, or n-octyl acrylate. The content of the alkyl acrylate(s) in all monomer units of (meth)acryl-based copolymer (A) is preferably from 60 to 99.9% by weight, more preferably from 70 to 99.9% by weight, even more preferably from 80 to 99.9% by weight, still more preferably from 80 to 99% by weight, and yet more preferably from 80 to 95% by weight.

In view of emulsion polymerization reactivity, the (meth)acryl-based copolymer (A) preferably has a water solubility in a specific range, and an alkyl methacrylate having an alkyl group of 1 to 18 carbon atoms may be used, so that the glass transition temperature can be easily controlled. Examples of the alkyl methacrylate include methylmethacrylate, ethyl methacrylate, propyl methacrylate, n-butyl methacrylate, tert-butyl methacrylate, n-hexyl methacrylate, cyclohexyl methacrylate, 2-ethylhexylmethacrylate, n-octylmethacrylate, lauryl methacrylate, tridecyl methacrylate, stearyl methacrylate, isobornyl methacrylate, and other alkyl esters of methacrylic acid. These may be used alone or in combination of two or more. Among these, methyl methacrylate, ethyl methacrylate, and cyclohexyl methacrylate are preferred. The content of the alkyl methacrylate(s) in all monomer units of (meth)acryl-based copolymer (A) is preferably 39.9% by weight or less, more preferably 30% by weight or less, even more preferably 20% by weight or less, still more preferably 15% by weight or less, and yet more preferably 10% by weight or less.

To improve the tackiness of the pressure-sensitive adhesive and provide stability for the emulsion, a carboxyl group-containing monomer is preferably used to form the (meth)acryl-based copolymer (A). The carboxyl group-containing monomer may be monomer having a carboxyl group and a radically-polymerizable unsaturated double bond-containing group such as a (meth)acryloyl group or a vinyl group, examples of which include (meth)acrylic acid, itaconic acid, maleic acid, fumaric acid, crotonic acid, carboxyethyl acrylate, and carboxypentyl acrylate. The content of the carboxyl group-containing monomer in all monomer units of the (meth)acryl-based polymer (A) is preferably from 0.1 to 10% by weight, more preferably from 0.5 to 7% by weight, and even more preferably from 1 to 6% by weight.

In addition to the alkyl (meth)acrylate and the carboxyl group-containing monomer, at least one copolymerizable monomer having an unsaturated double bond-containing polymerizable group such as a (meth)acryloyl group or a vinyl group may be introduced into the (meth)acryl-based polymer (A) by copolymerization in order to stabilize water dispersibility, to improve adhesion to a base material such as an optical film for the pressure-sensitive adhesive layer, and to improve initial tackiness to the adherend.

An alkoxysilyl group-containing monomer is mentioned as the copolymerizable monomer. The alkoxysilyl group-containing monomer may be a silane coupling agent-type unsaturated monomer having an alkoxysilyl group and a group having at least one unsaturated double bond, such as a (meth)acryloyl group or a vinyl group. The alkoxysilyl group-containing monomer is preferred in order to allow the (meth)acryl-based copolymer (A) to have a crosslinked structure and improved adhesion to glass.

Examples of the alkoxysilyl group-containing monomer include an alkoxysilyl group-containing (meth)acrylate monomer and an alkoxysilyl group-containing vinyl monomer. Examples of the alkoxysilyl group-containing (meth)acrylate monomer include (meth)acryloyloxyalkyl-trialkoxysilanes such as (meth)acryloyloxymethyl-trimethoxysilane, (meth)acryloyloxymethyl-triethoxysilane, 2-(meth)acryloyloxyethyl-trimethoxysilane, 2-(meth)acryloyloxyethyl-triethoxysilane, 3-(meth)acryloyloxypropyl-trimethoxysilane, 3-(meth)acryloyloxypropyl-triethoxysilane, 3-(meth)acryloyloxypropyl-tripropoxysilane, 3-(meth)acryloyloxypropyl-triisopropoxysilane, and 3-(meth)acryloyloxypropyl-tributoxysilane; (meth)acryloyloxyalkyl-alkyldialkoxysilanes such as (meth)acryloyloxymethyl-methyldimethoxysilane, (meth)acryloyloxymethyl-methyldiethoxysilane, 2-(meth)acryloyloxyethyl-methyldimethoxysilane, 2-(meth)acryloyloxyethyl-methyldiethoxysilane, 3-(meth)acryloyloxypropyl-methyldimethoxysilane, 3-(meth)acryloyloxypropyl-methyldiethoxysilane, 3-(meth)acryloyloxypropyl-methyldipropoxysilane, 3-(meth)acryloyloxypropyl-methyldiisopropoxysilane, 3-(meth)acryloyloxypropyl-methyldibutoxysilane, 3-(meth)acryloyloxypropyl-ethyldimethoxysilane, 3-(meth)acryloyloxypropyl-ethyldiethoxysilane, 3-(meth)acryloyloxypropyl-ethyldipropoxysilane, 3-(meth)acryloyloxypropyl-ethyldiisopropoxysilane, 3-(meth)acryloyloxypropyl-ethyldibutoxysilane, 3-(meth)acryloyloxypropyl-propyldimethoxysilane, and 3-(meth)acryloyloxypropyl-propyldiethoxysilane; and (meth)acryloyloxyalkyl-dialkyl(mono)alkoxysilanes corresponding to these monomers. For example, alkoxysilyl group-containing vinyl monomers include vinyltrialkoxysilanes such as vinyltrimethoxysilane, vinyltriethoxysilane, vinyltripropoxysilane, vinyltriisopropoxysilane, and vinyltributoxysilane, and vinylalkyldialkoxysilanes and vinyldialkylalkoxysilanes corresponding thereto; vinylalkyltrialkoxysilanes such as vinylmethyltrimethoxysilane, vinylmethyltriethoxysilane, β-vinylethyltrimethoxysilane, β-vinylethyltriethoxysilane, γ-vinylpropyltrimethoxysilane, γ-vinylpropyltriethoxysilane, γ-vinylpropyltripropoxysilane, γ-vinylpropyltriisopropoxysilane, and γ-vinylpropyltributoxysilane, and (vinylalkyl)alkyldialkoxysilanes and (vinylalkyl)dialkyl(mono)alkoxysilanes corresponding thereto.

The content of the alkoxysilyl group-containing monomer in all monomer components of the (meth)acryl-based polymer (A) is preferably from 0.001 to 1% by weight, more preferably from 0.01 to 0.5% by weight, and even more preferably from 0.03 to 0.1% by weight. If it is less than 0.001% by weight, the effect of using the alkoxysilyl group-containing monomer (providing a crosslinked structure and adhesion to glass) may be insufficiently obtained. If it is more than 1% by weight, the pressure-sensitive adhesive layer may have a too high degree of crosslinkage, so that the pressure-sensitive adhesive layer may crack over time.

The copolymerizable monomer may be a phosphate group-containing monomer. The phosphate group-containing monomer is effective in improving adhesion to glass.

For example, the phosphate group-containing monomer may be a phosphate group-containing monomer represented by formula (2) below.

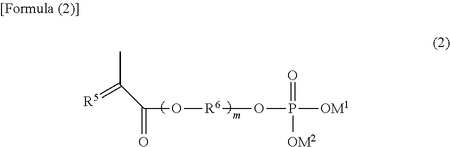

In formula (2), R⁵ represents a hydrogen atom or a methyl group, R⁶ represents an alkylene group of 1 to 4 carbon atoms, m represents an integer of 2 or more, and M¹ and M² each independently represent a hydrogen atom or a cation.

In formula (2), m is 2 or more, preferably 4 or more, generally 40 or less, and m represents the degree of polymerization of the oxyalkylene groups. The polyoxyalkylene group may be a polyoxyethylene group or a polyoxypropylene group, and these polyoxyalkylene groups may include random, block, or graft units. The cation of the salt of the phosphate group is typically, but not limited to, an inorganic cation such as an alkali metal such as sodium or potassium or an alkaline-earth metal such as calcium or magnesium, or an organic cation such as a quaternary amine.

The content of the phosphate group-containing monomer in all monomer components of the (meth)acryl-based polymer (A) is preferably 0.1 to 20% by weight, more preferably from 0.1 to 10% by weight, even more preferably 1 to 5% by weight. If the content is less than 0.1% by weight, the effect of using the phosphate group-containing monomer (suppression of the formation of linear bubbles) may tend to be insufficiently obtained, and a content of more than 20% by weight is not preferred in view of polymerization stability.

Examples of copolymerizable monomers other than the alkoxysilyl group-containing monomer and the phosphate group-containing monomer include acid anhydride group-containing monomers such as maleic anhydride and itaconic anhydride; aryl (meth)acrylate such as phenyl (meth)acrylate; vinyl esters such as vinyl acetate and vinyl propionate; styrene monomers such as styrene; epoxy group-containing monomers such as glycidyl (meth)acrylate and methylglycidyl (meth)acrylate; hydroxyl group-containing monomers such as 2-hydroxyethyl acrylate and 2-hydroxypropyl acrylate; nitrogen atom-containing monomers such as (meth)acrylamide, N,N-dimethyl(meth)acrylamide, N,N-diethyl(meth)acrylamide, N-isopropyl(meth)acrylamide, N-butyl(meth)acrylamide, N-methylol(meth)acrylamide, N-methylolpropane(meth)acrylamide, (meth)acryloylmorpholine, aminoethyl (meth)acrylate, N,N-dimethylaminoethyl (meth)acrylate, and tert-butylaminoethyl (meth)acrylate; alkoxy group-containing monomers such as methoxyethyl (meth)acrylate and ethoxyethyl (meth)acrylate; cyano group-containing monomers such as acrylonitrile and methacrylonitrile; functional monomers such as 2-methacryloyloxyethyl isocyanate; olefin monomers such as ethylene, propylene, isoprene, butadiene, and isobutylene; vinyl ether monomers such as vinyl ether; halogen atom-containing monomers such as vinyl chloride; and other monomers including vinyl group-containing heterocyclic compounds such as N-vinylpyrrolidone, N-(1-methylvinyl)pyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, and N-vinylmorpholine, and N-vinylcarboxylic acid amides.

Examples of the copolymerizable monomer also include maleimide monomers such as N-cyclohexylmaleimide, N-isopropylmaleimide, N-laurylmaleimide, and N-phenylmaleimide; itaconimide monomers such as N-methylitaconimide, N-ethylitaconimide, N-butylitaconimide, N-octylitaconimide, N-2-ethylhexylitaconimide, N-cyclohexylitaconimide, and N-laurylitaconimide; succinimide monomers such as N-(meth)acryloyloxymethylenesuccinimide, N-(meth)acryloyl-6-oxyhexamethylenesuccinimide, and N-(meth)acryloyl-8-oxyoctamethylenesuccinimide; and sulfonic acid group-containing monomers such as styrenesulfonic acid, allylsulfonic acid, 2-(meth)acrylamido-2-methylpropanesulfonic acid, (meth)acrylamidopropanesulfonic acid, sulfopropyl (meth)acrylate, and (meth)acryloyloxynaphthalenesulfonic acid.

Examples of the copolymerizable monomer also include glycol acrylate monomers such as polyethylene glycol (meth)acrylate, polypropylene glycol (meth)acrylate, methoxyethylene glycol (meth)acrylate, and methoxypolypropylene glycol (meth)acrylate; and other monomers such as acrylic ester monomers containing a heterocyclic ring or a halogen atom, such as tetrahydrofurfuryl (meth)acrylate and fluoro(meth)acrylate.

A polyfunctional monomer, other than the above alkoxysilyl group-containing monomer, may also be used as the copolymerizable monomer for a purpose such as control of the gel fraction of the water-dispersible pressure-sensitive adhesive composition. The polyfunctional monomer may be a compound having two or more unsaturated double bonds such as those in (meth)acryloyl groups or vinyl groups. Examples that may also be used include (meth)acrylate esters of polyhydric alcohols, such as (mono or poly)alkylene glycol di(meth)acrylates including (mono or poly)ethylene glycol di(meth)acrylates such as ethylene glycol di(meth)acrylate, diethylene glycol di(meth)acrylate, triethylene glycol di(meth)acrylate, trimethylolpropane tri(meth)acrylate, and tetraethylene glycol di(meth)acrylate, (mono or poly)propylene glycol di(meth)acrylate such as propylene glycol di(meth)acrylate, neopentyl glycol di(meth)acrylate, 1,6-hexanediol di(meth)acrylate, pentaerythritol di(meth)acrylate, trimethylolpropane tri(meth)acrylate, pentaerythritol tri(meth)acrylate, and dipentaerythritol hexa(meth)acrylate; polyfunctional vinyl compounds such as divinylbenzene; diacetone acrylamide; and compounds having two or more reactive unsaturated double bonds which have different reactivity respectively, such as allyl (meth)acrylate and vinyl (meth)acrylate. The polyfunctional monomer may also be a compound having a polyester, epoxy or urethane skeleton to which two or more unsaturated double bonds are added in the form of functional groups such as (meth)acryloyl groups or vinyl groups in the same manner as the monomer component, such as polyester (meth)acrylate, epoxy (meth)acrylate, or urethane (meth)acrylate.

When a monofunctional monomer is used as the copolymerizable monomer other than the alkoxysilyl group-containing monomer and the phosphate group-containing monomer, the content of the copolymerizable monomer in all monomer components of the (meth)acryl-based polymer (A) is preferably 20% by weight or less, more preferably 10% by weight or less, and even more preferably 5% by weight or less in view of the stability of the aqueous dispersion and prevention of an excessive increase in the viscosity of the aqueous dispersion. When a polyfunctional monomer is used as the copolymerizable monomer, the content of the copolymerizable monomer in all monomer components of the (meth)acryl-based polymer (A) is preferably 5% by weight or less, more preferably 3% by weight or less, and even more preferably 1% by weight or less in view of the stability of the aqueous dispersion.

The aqueous dispersion of the (meth)acryl-based copolymer (A) is obtained by polymerizing, in the presence of a surfactant and a radical polymerization initiator, a monomer component including an alkyl (meth)acrylate and a carboxyl group-containing monomer in water. The polymerization mode may be emulsion polymerization, suspension polymerization, or dispersion polymerization. The emulsion polymerization, the suspension polymerization, and the dispersion polymerization produce a polymer emulsion, a polymer suspension, and a polymer dispersion, respectively. The type of the pressure-sensitive adhesive polymer and the means for polymerization are selected depending on the type of the pressure-sensitive adhesive. The surfactant, which may be an emulsifying agent in the case of emulsion polymerization or a dispersing gent in the case of suspension polymerization, is appropriately selected depending on each polymerization mode.

In the invention, the aqueous dispersion for the water-dispersible pressure-sensitive adhesive composition is preferably an emulsion-type pressure-sensitive adhesive including a polymer emulsion obtained by emulsion polymerization.

According to a conventional technique, the monomer component may be emulsified in water and then subjected to emulsion polymerization. This process can form an aqueous dispersion (polymer emulsion) containing the (meth)acryl-based copolymer (A) as a base polymer. In the emulsion polymerization, for example, the monomer component may be appropriately mixed with a surfactant (emulsifying agent), a radical polymerization initiator, and an optional material such as a chain transfer agent. More specifically, each emulsion polymerization stage may be performed, for example, using a known emulsion polymerization method such as a batch mixing method (batch polymerization method), a monomer dropping method, or a monomer emulsion dropping method. In a monomer dropping method and a monomer emulsion dropping method, continuous dropping or intermittent dropping is appropriately selected. These methods may be combined as needed. Reaction conditions and other conditions are appropriately selected, in which, for example, the polymerization temperature is preferably from about 40 to about 95° C., and the polymerization time is preferably from about 30 minutes to about 24 hours.

The surfactant (emulsifying agent) for use in the emulsion polymerization may be, but not limited to, any of various surfactants commonly used in emulsion polymerization. As the surfactant, an anionic or a nonionic surfactant is generally used. Examples of the anionic surfactant include higher fatty acid salts such as sodium oleate; alkylarylsulfonate salts such as sodium dodecylbenzenesulfonate; alkylsulfate ester salts such as sodium laurylsulfate and ammonium laurylsulfate; polyoxyethylene alkyl ether sulfate ester salts such as sodium polyoxyethylene lauryl ether sulfate; polyoxyethylene alkyl aryl ether sulfate ester salts such as sodium polyoxyethylene nonyl phenyl ether sulfate; alkyl sulfosuccinic acid ester salts such as sodium monooctyl sulfosuccinate, sodium dioctyl sulfosuccinate, and sodium polyoxyethylene lauryl sulfosuccinate, and derivatives thereof; polyoxyethylene distyrenated phenyl ether sulfate ester salts; and sodium naphthalenesulfonate formalin condensation. Examples of the nonionic surfactant include polyoxyethylene alkyl ethers such as polyoxyethylene lauryl ether and polyoxyethylene stearyl ether; polyoxyethylene alkyl phenyl ethers such as polyoxyethylene octyl phenyl ether and polyoxyethylene nonyl phenyl ether; sorbitan higher fatty acid esters such as sorbitan monolaurate, sorbitan monostearate, and sorbitan trioleate; polyoxyethylene sorbitan higher fatty acid esters such as polyoxyethylene sorbitan monolaurate; polyoxyethylene higher fatty acid esters such as polyoxyethylene monolaurate and polyoxyethylene monostearate; glycerin higher fatty acid esters such as oleic acid monoglyceride and stearic acid monoglyceride; and polyoxyethylene-polyoxypropylene block copolymers, and polyoxyethylene distyrenated phenyl ether.

Besides the above non-reactive surfactants, a reactive surfactant having a radical-polymerizable functional group containing an ethylenic unsaturated double bond may be used as the surfactant. The reactive surfactant may be a radical-polymerizable surfactant prepared by introducing a radical-polymerizable functional group (radically reactive group) such as a propenyl group or an allyl ether group into the anionic surfactant or the nonionic surfactant. These surfactants may be appropriately used alone or in any combination. Among these surfactants, the radical-polymerizable surfactant having a radical-polymerizable functional group is preferably used in view of the stability of the aqueous dispersion or the durability of the pressure-sensitive adhesive layer.

Examples of anionic reactive surfactants include alkyl ether surfactants (examples of commercially available products include AQUALON KH-05, KH-10, and KH-20 manufactured by Dai-ichi Kogyo Seiyaku Co., Ltd., ADEKA REASOAP SR-10N and SR-20N manufactured by ADEKA CORPORATION, LATEMUL PD-104 manufactured by Kao Corporation, and others); sulfosuccinic acid ester surfactants (examples of commercially available products include LATEMUL S-120, S-120A, S-180P, and S-180A manufactured by Kao Corporation and ELEMINOL JS-20 manufactured by Sanyo Chemical Industries, Ltd., and others); alkyl phenyl ether surfactants or alkyl phenyl ester surfactants (examples of commercially available products include AQUALON H-2855A, H-3855B, H-3855C, H-3856, HS-05, HS-10, HS-20, HS-30, BC-05, BC-10, and BC-20 manufactured by Dai-ichi Kogyo Seiyaku Co., Ltd., and ADEKA REASOAP SDX-222, SDX-223, SDX-232, SDX-233, SDX-259, SE-10N, and SE-20N manufactured by ADEKA CORPORATION); (meth)acrylate sulfate ester surfactants (examples of commercially available products include ANTOX MS-60 and MS-2N manufactured by Nippon Nyukazai Co., Ltd., ELEMINOL RS-30 manufactured by Sanyo Chemical Industries Co., Ltd., and others); and phosphoric acid ester surfactants (examples of commercially available products include H-3330PL manufactured by Dai-ichi Kogyo Seiyaku Co., Ltd., ADEKA REASOAP PP-70 manufactured by ADEKA CORPORATION, and others). Examples of nonionic reactive surfactants include alkyl ether surfactants (examples of commercially available products include ADEKA REASOAP ER-10, ER-20, ER-30, and ER-40 manufactured by ADEKA CORPORATION, LATEMUL PD-420, PD-430, and PD-450 manufactured by Kao Corporation, and others); alkyl phenyl ether surfactants or alkyl phenyl ester surfactants (examples of commercially available products include AQUALON RN-10, RN-20, RN-30, and RN-50 manufactured by Dai-ichi Kogyo Seiyaku Co., Ltd., ADEKA REASOAP NE-10, NE-20, NE-30, and NE-40 manufactured by ADEKA CORPORATION, and others); and (meth)acrylate sulfate ester surfactants (examples of commercially available products include RMA-564, RMA-568, and RMA-1114 manufactured by Nippon Nyukazai Co., Ltd., and others).

The surfactant is preferably added in an amount of 0.3 to 15 parts by weight based on 100 parts by weight of the monomer component containing the alkyl (meth)acrylate. The addition of the surfactant in such an amount can improve adhesive properties and stability such as polymerization stability or mechanical stability. The surfactant is more preferably added in an amount of 0.3 to 5 parts by weight, even more preferably 0.3 to 4 parts by weight.

The radical polymerization initiator may be, but not limited to, any known radical polymerization initiator commonly used in emulsion polymerization. Examples include azo initiators such as 2,2′-azobisisobutylonitrile, 2,2′-azobis(2-methylpropionamidine)disulfate, 2,2′-azobis(2-methylpropionamidine)dihydrochloride, 2,2′-azobis(2-amidinopropane)dihydrochloride, and 2,2′-azobis[2-(2-imidazoline-2-yl)propane]dihydrochloride; persulfate initiators such as potassium persulfate and ammonium persulfate; peroxide initiators such as benzoyl peroxide, tert-butyl hydroperoxide, and hydrogen peroxide; substituted ethane initiators such as phenyl-substituted ethane; and carbonyl initiators such as aromatic carbonyl compounds. These polymerization initiators may be appropriately used alone or in any combination. If desired, the emulsion polymerization may be performed using a redox system initiator, in which a reducing agent is used in combination with the polymerization initiator. This makes it easy to accelerate the emulsion polymerization rate or to perform the emulsion polymerization at low temperature. Examples of such a reducing agent include reducing organic compounds such as ascorbic acid, erythorbic acid, tartaric acid, citric acid, glucose, and metal salts of formaldehyde sulfoxylate or the like; reducing inorganic compounds such as sodium thiosulfate, sodium sulfite, sodium bisulfite, and sodium metabisulfite; and ferrous chloride, Rongalite, and thiourea dioxide.

The content of the radical polymerization initiator is typically from about 0.02 to about 1 part by weight, preferably from 0.02 to 0.5 parts by weight, more preferably from 0.05 to 0.3 parts by weight, based on 100 parts by weight of the monomer components, while it is appropriately selected. If it is less than 0.02 parts by weight, the radical polymerization initiator may be less effective. If it is more than 1 part by weight, the (meth)acryl-based polymer (A) in the aqueous dispersion (polymer emulsion) may have a reduced molecular weight, so that the aqueous dispersion pressure-sensitive adhesive composition may have reduced durability. In the case of a redox system initiator, the reducing agent is preferably used in an amount of 0.01 to 1 part by weight based on 100 parts by weight of the total amount of the monomer components.

The chain transfer agent is used to control the molecular weight of the water-dispersible (meth)acryl-based polymer. Any chain transfer agent commonly used in emulsion polymerization may be used as needed. Examples include 1-dodecanthiol, mercaptoacetic acid, 2-mercaptoethanol, 2-ethylhexyl thioglycolate, 2,3-dimercapto-1-propanol, mercaptopropionic acid esters, and other mercaptans. These chain transfer agents may be appropriately used alone or in any combination. For example, the content of the chain transfer agent is 0.3 parts by weight or less, preferably from 0.001 to 0.3 parts by weight, based on 100 parts by weight of the monomer components.

The (meth)acryl-based copolymer (A) can be prepared in the form of an aqueous dispersion (emulsion) by such emulsion polymerization. The average particle size of the (meth)acryl-based copolymer (A) in the form of such an aqueous dispersion is typically adjusted to 0.05 to 3 μm, preferably adjusted to 0.05 to 1 μm. If the average particle size is less than 0.05 μm, the viscosity of the water-dispersible pressure-sensitive adhesive composition may increase, and if it is more than 1 μm, bonding between particles may decrease so that cohesive strength may decrease.

The (meth)acryl-based copolymer (A) in the aqueous dispersion contains a monomer unit derived from the carboxyl group-containing monomer. Therefore, the carboxyl group-containing monomer-derived component is preferably neutralized in order to maintain the stability of the aqueous dispersion. The neutralization can be performed, for example, using ammonia, an alkali metal hydroxide, or the like.

Generally, in the invention, the (meth)acryl-based copolymer (A) in the form of an aqueous dispersion preferably has a weight average molecular weight of 1,000,000 or more. In particular, the weight average molecular weight is preferably from 1,000,000 to 4,000,000 in view of heat resistance or moisture resistance. If the weight average molecular weight is less than 1,000,000, an undesired reduction in heat resistance or moisture resistance may occur. The pressure-sensitive adhesive obtained by the emulsion polymerization is preferred because the polymerization mechanism allows the adhesive to have a very high molecular weight. It should be noted that the pressure-sensitive adhesive obtained by the emulsion polymerization usually has a high gel content and cannot be subjected to GPC (gel permeation chromatography) measurement, which means that it is often difficult to identify the molecular weight by actual measurement.

The (meth)acryl-based copolymer (B) may have any monomer unit and any composition that satisfy the glass transition temperature requirements. Preferably, the (meth)acryl-based copolymer (B) is one obtained by emulsion polymerization of a monomer component containing an alkyl (meth)acrylate. More preferably, the (meth)acryl-based copolymer (B) is one obtained by emulsion polymerization of a monomer component including an alkyl (meth)acrylate and a carboxyl group-containing monomer.

The alkyl (meth)acrylate used to form the (meth)acryl-based copolymer (B) preferably has a water solubility in a certain range in view of its reactivity in emulsion polymerization. The alkyl (meth)acrylate as a main component is preferably a C₁ to C₁₈ alkyl methacrylate, examples of which are listed above for the (meth)acryl-based copolymer (A), because the use of the C₁ to C₁₈ alkyl methacrylate makes it easy to control the glass transition temperature. The alkyl methacrylates may be used alone or in combination of two or more. Examples of the alkyl methacrylate may be the same as those listed above. In particular, methyl methacrylate, ethyl methacrylate, tert-butyl methacrylate, isobornyl methacrylate, and cyclohexyl methacrylate are preferred among those listed above. The content of alkyl methacrylate is preferably 60 to 100% by weight, more preferably 70 to 99.9% by weight, even more preferably 80 to 99.9% by weight, further more preferably 80 to 99% by weight, and still more preferably 80 to 95% by weight of all monomers used to form the (meth)acryl-based copolymer (B).

A C₁ to C₁₈ alkyl acrylate, examples of which are listed above for the (meth)acryl-based copolymer (A), may also be used to form the (meth)acryl-based copolymer (B), because the material should preferably has a water solubility in a certain range in view of its reactivity in emulsion polymerization and the use of the C₁ to C₁₈ alkyl acrylate makes it easy to control the glass transition temperature. The alkyl acrylates may be used alone or in combination of two or more. Examples of the alkyl acrylate may be the same as those listed above. In particular, a C₃ to C₉ alkyl acrylate such as propyl acrylate, n-butyl acrylate, 2-ethylhexyl acrylate, or n-octyl acrylate is preferred among those listed above. The content of alkyl acrylate is preferably 39.9% by weight or less, more preferably 5 to 30% by weight, even more preferably 5 to 20% by weight of all monomers used to form the (meth)acryl-based copolymer (B).

The (meth)acryl-based copolymer (B) may include a monomer unit derived from the copolymerizable monomer, examples of which are listed above for the (meth)acryl-based copolymer (A). The copolymerizable monomer may be a carboxyl group-containing monomer, an alkoxysilyl group-containing monomer, a phosphate group-containing monomer, a polyfunctional monomer, or any other monomer. Any of these copolymerizable monomers may be used at the same content as that for the (meth)acryl-based copolymer (A). The method for preparing the aqueous dispersion of the (meth)acryl-based copolymer (B) may be the same as that for the (meth)acryl-based copolymer (A).

In the invention, the water-dispersible pressure-sensitive adhesive composition used to form the pressure-sensitive adhesive layer preferably includes an aqueous dispersion of the (meth)acryl-based copolymer (A) and an aqueous dispersion of the (meth)acryl-based copolymer (B) in a mixing ratio (solid weight ratio) (A)/(B) of 50/50 to 97/3. The mixing ratio is based on 100% by weight of the total of the solids in the aqueous dispersion of the (meth)acryl-based copolymer (A) and the solids in the aqueous dispersion of the (meth)acryl-based copolymer (B). When the aqueous dispersions of the (meth)acryl-based copolymers (A) and (B) are used in a ratio within this range, the pressure-sensitive adhesive can have reliable adhesion and be prevented from having lower cohesive strength. The content (solid weight content) of the (meth)acryl-based copolymer (A) in the aqueous dispersion is preferably 60% by weight or more. On the other hand, the content (solid weight content) of the (meth)acryl-based copolymer (A) in the aqueous dispersion may be 97% by weight or less, preferably 90% by weight or less, more preferably 80% by weight or less, even more preferably 80% by weight or less. If the content (solid weight content) of the (meth)acryl-based copolymer (A) in the aqueous dispersion is out of the range, the pressure-sensitive adhesive may tend to have lower cohesive strength and to be more likely to peel off.

In the invention, the water-dispersible pressure-sensitive adhesive composition used to form the pressure-sensitive adhesive layer can be prepared, for example, by mixing the aqueous dispersion of the (meth)acryl-based copolymer (A) and the aqueous dispersion of the (meth)acryl-based copolymer (B).

In the invention, the water-dispersible pressure-sensitive adhesive composition preferably includes emulsion particles each having a core-shell structure in which the (meth)acryl-based copolymer (B) forms a core layer and the (meth)acryl-based copolymer (A) forms a shell layer. The water-dispersible pressure-sensitive adhesive composition including emulsion particles with a core-shell structure can be prepared by a process that includes first preparing the aqueous dispersion of the (meth)acryl-based copolymer (B) (the core layer) and then subjecting a monomer component for the (meth)acryl-based copolymer (A) to emulsion polymerization to forma copolymer for the shell layer. In the process of preparing the emulsion particles with the core-shell structure, an emulsion of the (meth)acryl-based copolymer (A) and an emulsion of the (meth)acryl-based copolymer (B), which are not involved in forming the core-shell structure, can be produced. Therefore, the water-dispersible pressure-sensitive adhesive composition may also contain an emulsion of the (meth)acryl-based copolymer (A) and an emulsion of the (meth)acryl-based copolymer (B) in addition to the emulsion particles with the core-shell structure.

The water-dispersible pressure-sensitive adhesive composition for use in the invention may also contain an additional component other than the aqueous dispersions of the (meth)acryl-based copolymers (A) and (B). The content of such an additional component is preferably 10% by weight or less based on the total weight of the water-dispersible pressure-sensitive adhesive composition.

If necessary, the composition may contain a crosslinking agent as the additional component. When the water-dispersible pressure-sensitive adhesive composition is water-dispersible acrylic pressure-sensitive adhesive, the crosslinking agent to be used may be an isocyanate crosslinking agent, an epoxy crosslinking agent, an oxazoline crosslinking agent, an aziridine crosslinking agent, a carbodiimide crosslinking agent, a metal chelate crosslinking agent, or any other crosslinking agent commonly used in the art. When a functional group-containing monomer is used, these crosslinking agents have the effect of reacting with the functional group incorporated in the (meth)acryl-based copolymer (A) to form crosslinkage.

In general, the content of the crosslinking agent is preferably, but not limited to, about 10 parts by weight or less, more preferably 0.001 to 10 parts by weight, even more preferably 0.01 to 5 parts by weight (on a solids basis), based on 100 parts by weight of the total solids in the aqueous dispersions of the (meth)acryl-based copolymers (A) and (B). It should be noted that the use of the crosslinking agent can tend to reduce the tackiness and to cause moisture-induced peeling although the crosslinking agent can impart additional cohesive strength to the pressure-sensitive adhesive layer. In the invention, the crosslinking agent is not essential.

If necessary, the water-dispersible pressure-sensitive adhesive composition of the present invention may further appropriately contain any of various additives such as viscosity adjusting agent, releasing adjusting agent, tackifiers, plasticizers, softener, fillers including glass fibers, glass beads, metal power, or any other inorganic powder, pigments, colorants (pigments, dyes or the likes), pH adjusting agent (acid or base), antioxidants, and ultraviolet ray absorbing agents, silane coupling agents, without departing from the objects of the present invention. The water-dispersible pressure-sensitive adhesive composition may also contain fine particles to forma light-diffusing pressure-sensitive adhesive layer. These additives may also be added in the form of emulsion.

The pressure-sensitive adhesive layer for use in the invention can be formed by applying the water-dispersible pressure-sensitive adhesive composition to a supporting substrate (the optical member or a release film) and then drying the composition. The method for forming the pressure-sensitive adhesive layer will be described later.

(3) Optical Member

An optical film is preferably used as the optical member to form the pressure-sensitive adhesive layer-carrying optical member of the invention. The surface of the optical film may be subjected to any adhesion promoting treatment such as a corona treatment or a plasma treatment. Subsequently, the anchor layer and then pressure-sensitive adhesive layer may be formed on the treated surface of the optical film. The surface of the pressure-sensitive adhesive layer may also be subjected to an adhesion promoting treatment.

The optical film may be of any type used to form image display devices such as liquid crystal display devices. For example, the optical film may be a polarizing plate. The polarizing plate may generally include a polarizer and a transparent protective film or films provided on one or both sides of the polarizer.

The polarizer is not particularly limited, and those of various types may be used. Examples of the polarizer include a polarizer obtained by adsorbing a dichroic substance such as an iodine or a dichroic dye into a hydrophilic polymer film, such as a polyvinyl alcohol film, a partially formulated polyvinyl alcohol film or an ethylene/vinyl acetate copolymer partially saponified film, and then drawing the film monoaxially, or a polyene-oriented film made of, for example, a polyvinyl-alcohol dehydrated product or a polyvinyl-chloride dehydrochloride-treated product. Of such films, preferred is a polarizer composed of a polyvinyl alcohol film and a dichroic substance such as an iodine. The thickness of such a polarizer is not particularly limited, and in general, is approximately from 5 to 80 μm.

The polarizer obtained by dyeing a polyvinyl alcohol film with an iodine and then drawing the film monoaxially may be formed, for example, by immersing (a) polyvinyl alcohol (film) in an aqueous solution of iodine so as to be dyed, and then drawing the film into a length 3 to 7 times the original length. If necessary, the film may be immersed in an aqueous solution of potassium iodide or the like that may contain, for example, boric acid, zinc sulfate, or zinc chloride. Before dyeing, the polyvinyl alcohol film may be immersed in water to be washed as needed. Washing of the polyvinyl alcohol film with water makes it possible to clean off stains or a blocking inhibitor on surfaces of the polyvinyl alcohol film, and further causes the polyvinyl alcohol film to be swelled, thus producing an advantageous effect of preventing an unevenness in the dyed color or the like. The drawing may be performed after, while or before dyeing with iodine is performed. The drawing may be performed in an aqueous solution of boric acid, potassium iodide or the like, or in a water bath.

As the material constituting the transparent protective film, for example, a thermoplastic resin excellent in transparency, mechanical strength, thermal stability, water blocking performance, isotropy, and others are used. Specific examples of the thermoplastic resin include cellulose resins such as triacetylcellulose, polyester resin, polyethersulfone resin, polysulfone resin, polycarbonate resin, polyamide resin, polyimide resin, polyolefin resin, (meth)acrylate resin, cyclic polyolefin resin (norbornene based resin), polyarylate resin, polystyrene resin and polyvinyl alcohol resin; and mixtures thereof. The transparent protective film is bonded to one surface of the polarizer through the adhesive layer, while a thermosetting resin or ultraviolet curable resin of, for example, a (meth)acrylic, urethane, acrylic urethane, epoxy or silicone type may be used on the other surface as a transparent protective film. The transparent protective film may contain any one or more appropriate additives.

Examples of the additives include an ultraviolet absorbent, an antioxidant, a lubricant, a plasticizer, a release agent, a coloring inhibitor, a flame retardation, a nucleating agent, an antistatic agent, a pigment, and a colorant.

The content of the thermoplastic resin in the transparent protective film is preferably from 50 to 100% by weight, more preferably from 50 to 99% by weight, even more preferably from 60 to 98% by weight, in particular preferably from 70 to 97% by weight. If the content of the thermoplastic resin in the transparent protective film is less than 50% by weight, it is feared that a high transparency which a thermoplastic resin originally has cannot be sufficiently exhibited.

The optical film may be an optical layer that may be used to form, for example, a liquid crystal display device. Examples thereof include reflectors, anti-transmission plates, retardation plates, which may be, for example, ½ and ¼ wavelength plates, viewing angle compensation films, brightness enhancement films, and surface treatment films. These may be used alone as an optical film, or may be used in a form that two or more thereof are laminated onto the polarizing plate when practically used.

A surface treatment film may be provided by being bonded onto a front plate. Examples of the surface treatment film include a hard coat film for giving scratch resistance to a surface, an antiglare treatment film to prevent casting a glare on an image display device, and reflection reduction films such as an antireflective film and a low reflective film. The front plate is provided by being bonded onto the front surface of an image display device, such as a liquid crystal display device, an organic EL display device, a CRT or a PDP, to protect the image display device, give a high-class impression thereto, and discriminate the device from others by a design thereof. The front plate may be used as a supporter for a λ/4 plate in a 3D-TV. For example, in a liquid crystal display device, a front plate is located over its polarizing plate at the viewer-side of the device. When the pressure-sensitive adhesive layer in the present invention is used, a glass substrate as the front plate produces advantageous effects; besides, a plastic substrate, such as a polycarbonate substrate or polymethyl methacrylate substrate, produces the same advantageous effects.

The optical film in which two or more of the above-mentioned optical layers are laminated on a polarizing plate may be formed by a method of laminating the optical layers successively and individually in a process for producing, for example, a liquid crystal display device. The optical film obtained by laminating the optical layers beforehand is excellent in quality stability, fabricating workability and the like to produce an advantage of being able to enhance the process for producing a liquid crystal display device and the like. For the laminating, any appropriate adhesive means, such as a pressure-sensitive adhesive layer, may be used. When the polarizing plate is adhered to other optical layers, an optical axis of these members may be set to an appropriate layout angle in accordance with, for example, a target retardance property.

The pressure-sensitive adhesive layer-carrying optical member of the invention preferably has an anchoring strength of 25 N/25 mm or more, more preferably 28 N/25 mm or more, even more preferably 30 N/25 mm or more. As mentioned above, an anchor-layer-forming coating liquid prepared with an aqueous solvent including 60% by weight or more of water is used in the invention. The use of such an anchor-layer-forming coating liquid makes it possible to prevent a plasticizer and other components from leaching out of the surface of the optical member, which can improve the compatibility between the optical member and the pressure-sensitive adhesive layer made from the water-dispersible pressure-sensitive adhesive composition, so that a higher anchoring strength can be provided. The anchoring strength can be measured by the method described in the Examples section.

2. Method for Producing Pressure-Sensitive Adhesive Layer-Carrying Optical Member

The invention is also directed to a method for producing a pressure-sensitive adhesive layer-carrying optical member including an optical member, an anchor layer, and a pressure-sensitive adhesive layer provided on at least one side of the optical member with the anchor layer interposed therebetween, the method including the steps of:

applying an anchor-layer-forming coating liquid to an optical member and then drying the coating liquid to form an anchor layer, wherein the coating liquid includes a polythiophene based polymer, an oxazoline group-containing polymer, and an aqueous solvent including 60% by weight or more of water; and

forming a pressure-sensitive adhesive layer on the formed anchor layer, wherein the pressure-sensitive adhesive layer is made from a water-dispersible pressure-sensitive adhesive composition.

The water-dispersible pressure-sensitive adhesive composition, the anchor-layer-forming coating liquid, and the optical member may be those described above.

The production method of the invention may also include the step of performing an adhesion promoting treatment on the anchor layer-receiving surface of the optical member before the anchor layer is formed. In this case, the anchor-layer-forming coating liquid is applied to the adhesion promotion-treated surface of the optical member.

The adhesion promoting treatment may be, for example, a corona treatment or a plasma treatment. When the anchor layer-receiving surface of the optical member is subjected to a corona treatment or a plasma treatment, the pressure-sensitive adhesive layer can have higher tackiness to the optical member.

In general, when an anchor layer is formed after an adhesion promoting treatment is performed on an optical member to increase the tackiness between the optical member and a pressure-sensitive adhesive layer, the adhesion promoting treatment can produce oxalic acid and the like on the optical member to reduce the pH, so that a binder resin component in the anchor-layer-forming coating liquid may have reduced liquid stability to form a binder resin-derived contaminant. In the method of the invention for producing a pressure-sensitive adhesive layer-carrying optical member, however, the use of an aqueous solvent including 60% by weight or more of water makes it possible to maintain the liquid stability even when the pH of the binder component is reduced. As a result, the production of the binder-derived contaminant is prevented, so that the pressure-sensitive adhesive layer-carrying optical member is produced while the contamination of the anchor layer is prevented.

The adhesion promoting treatment performed on the surface of the optical film where the anchor layer is to be formed can produce oxalic acid and the like. Although not clearly understood, the mechanism of the production of oxalic acid and the like seems to be as follows. (A) When an electrical discharge is performed for the adhesion promoting treatment, high-energy electrons and ions collide with the surface of the optical member, so that radicals and ions are produced on the surface of the optical member. (B) The radicals and the ions react with the surrounding molecules such as N₂, O₂, and H₂, so that a polar reactive group such as a carboxyl group, a hydroxyl group, or a cyano group is introduced, and at the same time, oxalic acid is produced. If the anchor-layer-forming coating liquid is contaminated with the produced oxalic acid, the pH of the coating liquid will decrease, so that the production of contaminants in the anchor-layer-forming coating liquid will increase as mentioned above.

In the production method of the invention, the anchor-layer-forming coating liquid is preferably applied to the optical member so as to form a coating with a thickness of 20 μm or less (preferably 2 to 17 μm, more preferably 4 to 13 μm) before drying. If the coating before drying is too thick (the amount of the applied anchor-layer-forming coating liquid is too large), the solvent may easily affect the coating and promote cracking. If the coating is too thin, the adhesion between the optical member and the pressure-sensitive adhesive layer may be insufficient, which may reduce durability. Thus, the thickness of the coating is preferably from 2 to 17 μm, more preferably from 4 to 13 μm to prevent cracking and improve durability. The coating thickness before drying can be calculated from the thickness of the anchor layer after drying and the content of the binder resin in the anchor-layer-forming coating liquid.

The anchor-layer-forming coating liquid may be applied by any application method such as coating, dipping, or spraying.

After applied, the anchor-layer-forming coating liquid is subjected to drying, in which the drying temperature and the drying time are typically, but not limited to, about 40 to about 70° C. and about 5 to about 200 seconds, respectively.

After the drying, the anchor layer preferably has a thickness (dry thickness) of 3 to 300 nm, more preferably 5 to 180 nm, even more preferably 11 to 90 nm. An anchor layer with a thickness of less than 3 nm may be not enough to ensure the anchoring between the optical member and the pressure-sensitive adhesive layer. On the other hand, an anchor layer with a thickness of more than 300 nm may be too thick to have sufficient strength, so that cohesive failure may easily occur in such an anchor layer and sufficient anchoring may fail to be achieved in some cases.

The pressure-sensitive adhesive layer-carrying optical member of the invention can be produced by forming the anchor layer on the optical member and then forming the pressure-sensitive adhesive layer on the anchor layer of the resulting anchor layer-carrying optical member.

Examples of the method for depositing the pressure-sensitive adhesive layer include, but are not limited to, a method including applying the water-dispersible pressure-sensitive adhesive composition to the anchor layer of the anchor layer-carrying optical member and drying the composition to form a pressure-sensitive adhesive layer; and a method including forming a pressure-sensitive adhesive layer on a release sheet and transferring the pressure-sensitive adhesive layer onto the anchor layer.

Any of various methods may be used in the step of applying the water-dispersible pressure-sensitive adhesive composition. Examples of the application method include roll coating, kiss roll coating, gravure coating, reverse coating, roll brush coating, spray coating, dip roll coating, bar coating, knife coating, air knife coating, curtain coating, lip coating, die coating, and any other extrusion coating.

In the applying step, the amount of the application is so controlled that a pressure-sensitive adhesive layer can be formed with a desired thickness (post-drying thickness). The thickness (post-drying thickness) of the pressure-sensitive adhesive layer is generally from about 1 to about 100 μm, preferably from 5 to 50 μm, more preferably from 10 to 40 μm.

In the process of forming the pressure-sensitive adhesive layer, the applied water-dispersible pressure-sensitive adhesive composition is then subjected to drying. The drying temperature is generally from about 80 to about 170° C., preferably from 80 to 160° C. The drying time is generally from about 0.5 to about 30 minutes, preferably from 1 to 10 minutes.

The material used to form the release film may be any appropriate thin material, examples of which include a plastic film such as a polyethylene, polypropylene, polyethylene terephthalate, or polyester film, a porous material such as a paper sheet, a cloth, or a nonwoven fabric, a net, a foam sheet, a metal foil, and any laminate thereof. A plastic film is advantageously used because it has high surface smoothness.

Such a plastic film may be of any type capable of protecting the pressure-sensitive adhesive layer. For example, such a plastic film may be a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, or an ethylene-vinyl acetate copolymer film.

The thickness of the release film is generally from about 5 to about 200 μm, preferably from about 5 to about 100 μm. If necessary, the release film may be subjected to a release treatment and an antifouling treatment with a silicone, fluoride, long-chain alkyl, or fatty acid amide release agent, silica powder, or the like, or subjected to an antistatic treatment of coating type, kneading and mixing type, vapor-deposition type, or the like. Particularly when the surface of the release film is appropriately subjected to a release treatment such as a silicone treatment, a long-chain alkyl treatment, or a fluorine treatment, the releasability from the pressure-sensitive adhesive layer can be further increased.

When the pressure-sensitive adhesive layer is exposed, the pressure-sensitive adhesive layer may be protected by a release film until it is actually used. The release film may be used by itself as a separator for the pressure-sensitive adhesive layer-carrying optical member, so that the process can be simplified.

3. Image Display Device

The pressure-sensitive adhesive layer-carrying optical member of the present invention is preferably usable for formation of various image display devices such as a liquid crystal display device, and others. The liquid crystal display device may be formed according to the prior art. Specifically, a liquid crystal display device is generally formed, for example, by fabricating appropriately a liquid crystal cell, a pressure-sensitive adhesive layer-carrying optical member, an optional lighting system and other constituent members as needed, and integrating a driving circuit thereinto. In the present invention, a liquid crystal display device is formed according to such a conventional method, and is not particularly limited except that the pressure-sensitive adhesive layer-carrying optical member according to the present invention is used. For the liquid crystal cell, a cell in any mode, such as a TN, STN, π, VA, or IPS mode may be used.

The present invention is used to make it possible to form an appropriate liquid crystal display device, such as a liquid crystal display device in which the pressure-sensitive adhesive layer-carrying optical member is arranged on one or both surfaces of a display panel such as a liquid crystal cell, or a display device in which a backlight or a reflector is used for a lighting system. In this case, the optical member according to the present invention may be provided at one or both sides of the display panel such as the liquid crystal cell. When the optical members are provided at both sides, the optical members may be the same or different. Further, when the liquid crystal display device is formed, any appropriate members such as a diffusion plate, an antiglare layer, a reflection reduction film, a protective plate, a prism array, a lens array sheet, a light diffusion plate, a backlight and the like may be arranged as one or more layers at any appropriate positions.

The following will describe an organic electroluminescence device (organic EL display device: OLED). Generally, in an organic EL display device, a transparent electrode, an organic luminous layer and a metal electrode are laminated in order onto a transparent substrate to forma luminous body (organic electroluminescence body). Here, the organic luminous layer is a laminate composed of various organic thin films. As the structure of this layer, structures having a combination that may be of various types are known, for example, a laminate composed of a hole injection layer made of, for example, a triphenylamine derivative, and a luminous layer made of a fluorescent organic solid such as anthracene, a laminate composed of such a luminous layer and an electron injection layer made of, for example, a perylene derivative, or a laminate composed of a hole injection layer, a luminous layer and an electron injection layer as described herein.

In an organic EL display device, by applying a voltage to its transparent electrode and its metal electrode, holes and electrons are injected into the organic luminous layer, and these holes and electrons are recombined to generate an energy. In turn, the energy excites the fluorescent substance. When the excited fluorescent substance is returned to a ground state thereof, light is radiated. By this principle, light is emitted. The mechanism of the recombination in the middle of this process is equivalent to that of ordinary diodes. As can be expected also from this matter, the electric current and the luminescence intensity show an intense non-linearity, with rectification, relative to an applied voltage.

In an organic EL display device, at least one of its electrodes needs to be transparent to take out luminescence from its organic luminous layer. Usually, its transparent electrode made of a transparent electroconductor such as indium tin oxide (ITO) is used as a positive electrode. Meanwhile, in order to make the injection of electrons easy to raise the luminescence efficiency, it is important to use a substance with small working function for a negative electrode. Usually, an electrode made of a metal, such as Mg—Ag or Al—Li, is used.

In an organic EL display device having such a structure, its organic luminous layer is formed of a very thin film having a thickness of about 10 nm. Thus, like the transparent electrode, the organic luminous layer transmits light substantially completely. As a result, when no light is emitted, light enters from a surface of the transparent substrate, penetrates the transparent electrode and the organic luminous layer and then reflects on the metal electrode and again goes out to the surface of the transparent substrate. Accordingly, when the organic EL display device is viewed from the outside, the display surface of the device looks like a mirror plane.

In an organic EL display device containing an organic electroluminescent body which is formed by providing a transparent electrode on the front surface side of the organic luminous layer which emits light by applying a voltage thereto, and further providing a metal electrode on the rear surface side of the organic luminous layer, a polarizing plate may be located on the front surface side of the transparent electrode and further a retardation plate may be interposed between the transparent electrode and the polarizing plate.

Since the retardation plate and the polarizing plate have an action of polarizing light radiated thereinto from the outside and then reflected on the metal electrode, there is an effect that the mirror plane of the metal electrode cannot be viewed from the outside by the polarizing action. In particular, when the retardation plate is composed of a ¼ wavelength plate and the angle between the respective polarizing directions of the polarizing plate and the retardation plate is adjusted to π/4, the mirror plane of the metal electrode can be completely shielded.

In short, about external light radiated into this organic EL display device, only its linearly polarized light component is transmitted by effect of the polarizing plate. This linearly polarized light ray is generally turned to an elliptically polarized light ray by effect of the retardation plate. However, particularly, when the retardation plate is a ¼ wavelength plate and further the angle between the respective polarizing directions of the polarizing plate and the retardation plate is π/4, the light ray is turned to a circularly polarized light ray.

This circularly polarized light ray is transmitted through the transparent substrate, the transparent electrode, and the organic thin film, reflected on the metal electrode, and again transmitted through the organic thin film, the transparent electrode and the transparent substrate to be again turned to a linearly polarized light ray through the retardation plate. This linearly polarized light ray is perpendicular to the polarizing direction of the polarizing plate so as not to be transmissible through the polarizing plate. As a result, the mirror plane of the metal electrode can be completely shielded.

### EXAMPLES

Hereinafter, the present invention will be specifically described by way of examples. However, the present invention is not limited by these examples. In each of the examples, the word “part(s)” and the symbol “%” denote “part(s) by weight” and “% by weight”, respectively.

### Example 1

### Preparation of Polarizing Film

A polyvinyl alcohol (PVA) film (average degree of polymerization: 2,400, degree of saponification: 99.9% by mole, thickness: 75 μm) was immersed in warm water at 30° C. for 60 seconds so that it was allowed to swell. The film was then immersed in an aqueous solution of 0.3% iodine/potassium iodide (0.5/8 in weight ratio) and dyed while stretched to 3.5 times. The film was then stretched to a total stretch ratio of 6 times in an aqueous boric ester solution at 65° C., resulting in a polarizer. Triacetylcellulose (TAC) films as transparent protective films were bonded to both sides of the polarizer with a PVA-based adhesive to form a polarizing film.

(Preparation of Monomer Emulsion (1))

A monomer emulsion (1) was prepared by adding 13 parts of butyl acrylate (BA), 80 parts of methyl methacrylate (MMA), 5 parts of cyclohexyl methacrylate (CHMA), 2 parts of acrylic acid (AA), 0.04 parts of 3-methacryloyloxypropyl-triethoxysilane (KBM-503 (trade name) manufactured by Shin-Etsu Chemical Co., Ltd.), 44 parts of an emulsifying agent (AQUALON HS-1025 (trade name) manufactured by DKS Co. Ltd.), and 415 parts of water as raw materials to a glass beaker and stirring them at 6,000 rpm for 5 minutes with a homomixer (manufactured by PRIMIX Corporation).

(Preparation of Monomer Emulsion (2))

A monomer emulsion (2) was prepared by adding 86.7 parts of butyl acrylate (BA), 5 parts of cyclohexyl methacrylate (CHMA), 2.5 parts of a phosphate group-containing monomer (Sipomer PAM-200 (trade name), mono[poly(propyleneoxide)methacrylate]phosphate ester, manufactured by Rhodia), 5.8 parts of acrylic acid (AA), 0.04 parts of 3-methacryloyloxypropyl-triethoxysilane (KBM-503 (trade name) manufactured by Shin-Etsu Chemical Co., Ltd.), 4 parts of an emulsifying agent (AQUALON HS-1025 (trade name) manufactured by DKS Co. Ltd.), and 108 parts of water as raw materials to a glass beaker and stirring them at 6,000 rpm for 5 minutes with a homomixer.

(Preparation of Water-Dispersible Pressure-Sensitive Adhesive Composition)

Subsequently, 55.9 parts of the monomer emulsion (1) prepared as described above was added to a reaction vessel equipped with a condenser tube, a nitrogen inlet tube, a thermometer, a dropping funnel, and a stirring blade. Subsequently, after the reaction vessel was sufficiently purged with nitrogen, the temperature of the inner bath was adjusted to 65° C. After 0.1 parts of a sodium ammonium peroxosulfate (APS) aqueous solution (5%) was added to the reaction vessel, batch polymerization was started with stirring at a rate of 150 rpm. The polymerization was performed for 1 hour with the inner bath temperature kept at 65° C. After the batch polymerization, 0.5 parts of an APS aqueous solution was added to the vessel and then mixed for 10 minutes while the inner bath temperature was kept at 65° C. Subsequently, dropping polymerization was started while 84.8 parts of the monomer emulsion (2) was added dropwise to the vessel over 3 hours with the inner bath temperature kept at 65° C. After the dropping polymerization, polymerization was performed for 3 hours with the inner bath temperature kept at 65° C. The resulting aqueous dispersion containing polymers obtained by polymerization of the polymerizable mixture was cooled to room temperature. The pH of the aqueous dispersion was adjusted to 7.8 by adding 10% ammonia water, so that a water-dispersible pressure-sensitive adhesive composition with a solid concentration of 36% was obtained. The Tg of the polymer obtained from the monomer emulsion (1) was 73.4° C., and the Tg of the polymer obtained from the monomer emulsion (2) was −34.6° C. The Tg values were calculated by the method described herein. The following Tg (K) of a homopolymer of each monomer was used in the calculation of the Tg values.

### BA: 228.15 K

### AA: 379.15 K

### MMA: 378.15 K

### CHMA: 339.15 K

Phosphate group-containing monomer: 273.15 K

(Preparation of Anchor Layer)

An anchor-layer-forming coating liquid with a solid concentration of 0.5% by weight was prepared by mixing 8.6 parts of a solution containing 10 to 50% by weight (on a solid basis) of a thiophene polymer (Denatron P-580W (trade name) manufactured by Nagase ChemteX Corporation), 1 part of a solution containing an oxazoline group-containing acrylic polymer (EPOCROS WS-700 (trade name) manufactured by NIPPON SHOKUBAI CO., LTD.), and 90.4 parts of water. The resulting anchor-layer-forming coating liquid contained 0.04% by weight of the polythiophene based polymer and 0.25% by weight of the oxazoline group-containing acrylic polymer. The alcohol content of the resulting anchor-layer-forming coating liquid was 0% by weight. After the preparation, the coating liquid was applied to the polarizing film with Mayer Bar #5 and then dried at 40° C. for 120 seconds to forma 50-nm-thick anchor layer, so that an anchor layer-carrying polarizing film was obtained. The resulting anchor layer contained 8% by weight of the thiophene polymer and 50% by weight of the oxazoline group-containing acrylic polymer.

The thickness of the anchor layer was measured by the following method.

### <Measurement of the Anchor Layer Thickness>

The anchor layer-carrying polarizing film was stained with an aqueous solution of 2% ruthenic acid for 2 minutes. The stained product was encapsulated with epoxy resin and then cut into about 80-nm-thick slices with an ultramicrotome (Ultracut S manufactured by Leica). Subsequently, the cross-section of the polarizing film slice was observed with a transmission electron microscope (TEM) (H-7650 manufactured by Hitachi, acceleration voltage 100 kV), when the dry thickness (nm) of the anchor layer after the drying was determined.

(Preparation of Pressure-Sensitive Adhesive Layer-Carrying Polarizing Film)

The water-dispersible pressure-sensitive adhesive composition was applied to the surface of a silicone release agent-treated PET film substrate (MRF-38 (trade name) manufactured by Mitsubishi Plastics, Inc.) by die coating and then dried in an air circulation-type thermostatic oven at a drying temperature of 120° C. for 2 minutes, so that a 25-μm-thick pressure-sensitive adhesive layer was formed on the surface of the substrate. Subsequently, the pressure-sensitive adhesive layer-carrying PET substrate was attached to the anchor layer-carrying polarizing film to form a pressure-sensitive adhesive layer-carrying polarizing film.

### Example 2

A pressure-sensitive adhesive layer-carrying polarizing film was prepared as in Example 1, except that “EPOCROS WS-500” was used instead of “EPOCROS WS-700” in the preparation of the anchor layer.

### Example 3

A pressure-sensitive adhesive layer-carrying polarizing film was prepared as in Example 1, except that “EPOCROS WS-300” was used instead of “EPOCROS WS-700” in the preparation of the anchor layer.

### Comparative Example 1

A pressure-sensitive adhesive layer-carrying polarizing film was prepared as in Example 1, except that “EPOCROS WS-700” was not added in the preparation of the anchor layer.

### Comparative Example 2

A pressure-sensitive adhesive layer-carrying polarizing film was prepared as in Example 1, except that “Denatron P-580W” was not added in the preparation of the anchor layer.

### Comparative Examples 3 to 6

Pressure-sensitive adhesive layer-carrying polarizing films were prepared as in Example 1, except that a mixed solvent containing 50% by weight of water and 50% by weight of isopropyl alcohol (Comparative Example 3), a mixed solvent containing 40% by weight of water and 60% by weight of isopropyl alcohol (Comparative Example 4), a mixed solvent containing 30% by weight of water and 70% by weight of isopropyl alcohol (Comparative Example 5), and a mixed solvent containing 20% by weight of water and 80% by weight of isopropyl alcohol (Comparative Example 6) were used, respectively, instead of water as the solvent, in the preparation of the anchor layer.

The pressure-sensitive adhesive layer-carrying polarizing films obtained in the examples and the comparative examples were evaluated as described below. Table 1 shows the evaluation results.

<Conduction Properties (Time Required for ESD-Induced Unevenness to Disappear)>

A 50 mm×50 mm piece was cut from the pressure-sensitive adhesive layer-carrying polarizing film prepared in each of the examples and the comparative examples, and then the PET film was peeled off from the cut piece. The resulting piece was bonded to the vapor-deposited ITO layer-free surface of an IPS panel. A pressure-sensitive adhesive layer-carrying optical film was separately prepared and bonded to the vapor-deposited ITO surface opposite to the above surface so that the polarizing film and the optical film formed crossed Nicols to block light from passing through. The IPS panel with the pressure-sensitive adhesive layer-carrying optical film bonded thereto was gently placed on a backlight. Subsequently, contact discharge of 10 kV static electricity was performed on the surface of the pressure-sensitive adhesive layer-carrying polarizing film containing the anchor layer prepared in each of the examples and the comparative examples using an electrostatic tester (ESS-B3011 (electrostatic discharge simulator) and GT-30R (discharge gun) both manufactured by NOISE LABORATORY CO., LTD.). In this process, the time (seconds) taken for the display on the IPS panel to change from black to white for an instant and then back to black was measured and used as an electrical characteristic. The shorter the black/white conversion time is, the better the electrical characteristic is. These series of procedures were performed under the atmosphere at 23° C. and 55% RH.

<Reduction in Single-Piece Transmittance>

The transmittance of the polarizing film before the deposition of the anchor layer and the transmittance of the anchor layer-carrying polarizing film obtained in each of the examples and the comparative examples were measured, respectively, and used for the calculation of (the transmittance of the polarizing film)−(the transmittance of the anchor layer-carrying polarizing film). The transmittance was measured as follows. A sample piece with a size of 50 mm×25 mm was cut from the widthwise central part of each of the polarizing film and the anchor layer-carrying polarizing film in such a way that the absorption axis of the polarizing film made an angle of 45° with the long side. The sample piece was then measured for single-piece transmittance (%) using an integrating sphere type transmittance meter (DOT-3C manufactured by Murakami Color Research Laboratory).

<Anchoring Strength>

The PET film was peeled off from the pressure-sensitive adhesive layer-carrying polarizing film obtained in each of the examples and the comparative examples. An ITO film (125 Tetolight OES manufactured by OIKE &Co., Ltd.) was then bonded to the exposed surface of the pressure-sensitive adhesive layer-carrying polarizing film. A 25-mm-wide piece was cut from the resulting laminate. Using a tensile tester, the pressure-sensitive adhesive layer-carrying polarizing film was peeled off from the laminate at an angle of 180° and a rate of 300 mm/minute. The resulting peel strength (N/25 mm) was determined as the anchoring strength.

<Coating Appearance>

The coating appearance of the anchor layer-carrying polarizing film obtained in each of the examples and the comparative examples was examined visually. The following evaluation criteria were used.

◯: The coating appearance is good with no cissing, coating unevenness, or contamination.
Δ: The coating appearance has no effect on visibility although cissing or coating unevenness appears.
x: The coating appearance is not acceptable for practical use due to significant cissing, coating unevenness, or contamination.

<Durability>

A 15-inch sized piece was cut from the pressure-sensitive adhesive layer-carrying polarizing film obtained in each of the examples and the comparative examples, and then the PET film was peeled off from the cut piece. The cut piece was then bonded to a 0.7-mm-thick non-alkali glass sheet (Eagle XG). The resulting laminate was then allowed to stand in an autoclave at 50° C. and 0.5 MPa for 15 minutes. Subsequently, the laminate was stored in an environment at 80° C. and an environment at 60° C. and 90% RH for 500 hours and then taken out to room temperature conditions (23° C. and 55% RH), immediately after which the degree of defects between the stored pressure-sensitive adhesive-type optical film and the non-alkali glass sheet was observed visually and evaluated according to the criteria below.

◯: No delamination or bubble-shaped defect occurs.
Δ: Delamination occurs over a length of at most 1.0 mm from the end of the pressure-sensitive adhesive-type optical film.
x: Delamination occurs over a length of more than 1.0 mm from the end of the pressure-sensitive adhesive-type optical film.

TABLE 1

| | Anchor layer | | | | | | | | | |
|---|---|---|---|---|---|---|---|---|---|---|
| | polythiophene | | Oxazoline | | | | | | | |
| | based | | group- | | | | | | | |
| | polymer | | containing | | | | | | | |
| | (conductive | | polymer | | Solvent | Properties | | | | |
| | agent) | | (binder) | | Alcohol | Conduction | Reduction | Anchoring | | |
| | | Content | | Content | content | properties | (%) in | strength | Coating | |
| | Type | (wt %) | Type | (wt %) | (wt %) | (seconds) | transmittance | (N/25 mm) | appearance | Durability |
| Example 1 | P-580W | 0.25 | WS-700 | 0.25 | 0 | 0 | −0.2 | 30 | ◯ | ◯ |
| Example 2 | P-580W | 0.25 | WS-500 | 0.25 | 0 | 0 | −0.2 | 30 | ◯ | ◯ |
| Example 3 | P-580W | 0.25 | WS-300 | 0.25 | 0 | 0 | −0.2 | 30 | ◯ | ◯ |
| Comparative | P-580W | 0.25 | — | — | 0 | 0 | −0.2 | 15 | X | X |
| Example 1 | | | | | | | | | | |
| Comparative | — | — | WS-700 | 0.25 | 0 | >60 | 0.0 | 35 | ◯ | ◯ |
| Example 2 | | | | | | | | | | |
| Comparative | P-580W | 0.25 | WS-700 | 0.25 | 50 | 0 | −0.2 | 23 | ◯ | ◯ |
| Example 3 | | | | | | | | | | |
| Comparative | P-580W | 0.25 | WS-700 | 0.25 | 60 | 0 | −0.2 | 20 | ◯ | Δ |
| Example 4 | | | | | | | | | | |
| Comparative | P-580W | 0.25 | WS-700 | 0.25 | 70 | — | — | — | X | — |
| Example 5 | | | | | | | | | | |
| Comparative | P-580W | 0.25 | WS-700 | 0.25 | 80 | — | — | — | X | — |
| Example 6 | | | | | | | | | | |

In Comparative Examples 5 and 6, the anchor-layer-forming coating liquid was less stable and underwent separation, which made it impossible to prepare any sample for measurement and thus made it impossible to measure the conduction properties, the reduction in single-piece transmittance, the anchoring strength, and the durability.

In Table 1, the abbreviations have the following meanings.

P-580W: Denatron P-580W, a solution containing 10 to 50% by weight of a thiophene polymer, manufactured by Nagase ChemteX Corporation

WS-700: EPOCROS WS-700, a solution containing an oxazoline group-containing acrylic polymer, manufactured by NIPPON SHOKUBAI CO., LTD.

WS-500: EPOCROS WS-500, a solution containing an oxazoline group-containing acrylic polymer, manufactured by NIPPON SHOKUBAI CO., LTD.

WS-300: EPOCROS WS-300, a solution containing an oxazoline group-containing acrylic polymer, manufactured by NIPPON SHOKUBAI CO., LTD.

1. A pressure-sensitive adhesive layer-carrying optical member, comprising:
a pressure-sensitive adhesive layer made from a water-dispersible pressure-sensitive adhesive composition;
an anchor layer made from an anchor-layer-forming coating liquid; and
an optical member, wherein
the anchor-layer-forming coating liquid comprises a polythiophene based polymer, an oxazoline group-containing polymer, and an aqueous solvent comprising 60% by weight or more of water, and
the anchor layer is interposed between the pressure-sensitive adhesive layer and the optical member.

2. The pressure-sensitive adhesive layer-carrying optical member according to claim 1, wherein the anchor-layer-forming coating liquid contains 0.005 to 5% by weight of the polythiophene based polymer and 0.005 to 5% by weight of the oxazoline group-containing polymer.

3. The pressure-sensitive adhesive layer-carrying optical member according to claim 1, wherein there is a difference (A−B) of 1.0% or less between the transmittance A of the optical member before deposition of the anchor layer and the transmittance B of the anchor layer-carrying optical member.

4. The pressure-sensitive adhesive layer-carrying optical member according to claim 1, wherein the water-dispersible pressure-sensitive adhesive composition is an aqueous dispersion comprising (A) a (meth)acryl-based copolymer with a glass transition temperature of −55° C. or more and less than 0° C. and (B) another (meth)acryl-based copolymer with a glass transition temperature of 0° C. or more.

5. The pressure-sensitive adhesive layer-carrying optical member according to claim 4, wherein the (meth)acryl-based copolymers (A) and (B) are each a copolymer obtained by emulsion polymerization of a monomer component comprising an alkyl (meth)acrylate and a carboxyl group-containing monomer.

6. The pressure-sensitive adhesive layer-carrying optical member according to claim 4, wherein the water-dispersible pressure-sensitive adhesive composition contains emulsion particles each having a core-shell structure in which the (meth)acryl-based copolymer (B) forms a core layer and the (meth)acryl-based copolymer (A) forms a shell layer.

7. The pressure-sensitive adhesive layer-carrying optical member according to claim 1, wherein the optical member is a polarizing film.

8. An image display device comprising the pressure-sensitive adhesive layer-carrying optical member according to claim 1.

9. A method for producing the pressure-sensitive adhesive layer-carrying optical member according to claim 1 comprising an optical member, an anchor layer, and a pressure-sensitive adhesive layer provided on at least one side of the optical member with the anchor layer interposed therebetween, the method comprising the steps of:
applying an anchor-layer-forming coating liquid to an optical member and then drying the coating liquid to form an anchor layer, wherein the coating liquid comprises a polythiophene based polymer, an oxazoline group-containing polymer, and an aqueous solvent comprising 60% by weight or more of water; and
forming a pressure-sensitive adhesive layer on the formed anchor layer, wherein the pressure-sensitive adhesive layer is made from a water-dispersible pressure-sensitive adhesive composition.
